(19) United States
(12) Patent Application Publication
(10) Pub. No.: US 2013/0267157 A1
(43) Pub. Date: Oct. 10, 2013

(54) METHOD AND SYSTEM FOR PREVENTING EXHAUST INFLOW OF VEHICLE

(71) Applicants: HYUNDAI MOTOR COMPANY, Seoul (KR); KIA MOTORS CORP., Seoul (KR)

(72) Inventors: Jun Kyu Park, Hwaseong-si (KR); Moo Yong KIM, Suwon-si (KR)

(73) Assignees: Kia Motors Corp., Seoul (KR); Hyundai Motor Company, Seoul (KR)

(21) Appl. No.: 13/676,750

(22) Filed: Nov. 14, 2012

(30) Foreign Application Priority Data
Apr. 10, 2012 (KR) 10-2012-0037040

(51) Int. Cl. B60H 1/00

(52) U.S. Cl. CPC B60H 1/008; B60H 1/00821
USPC 454/70; 454/75; 454/156

(57) ABSTRACT

Disclosed is a method of preventing an exhaust inflow, including: a measurement step of measuring a concentration of exhaust introduced into an interior of a vehicle through an exhaust detecting sensor installed in the interior of the vehicle, and comparing the concentration of the exhaust with a reference concentration; an introduction step of controlling an interior/exterior air door of an air conditioning apparatus to introduce more exterior air into the interior of the vehicle so as to increase an interior pressure when the concentration of the introduced exhaust is thicker than the reference concentration; and a blowing step of controlling a blower of the air conditioning apparatus to increase an amount of air discharged into the interior of the vehicle to increase the interior pressure when the thick concentration of the exhaust is maintained.

### CROSS-REFERENCE TO RELATED APPLICATION

The present application claims priority to Korean Patent Application No. 10-2012-0037040, filed on Apr. 10, 2012, the entire contents of which is incorporated herein for all purposes by this reference.

### BACKGROUND OF THE INVENTION

1. Field of the Invention

The present invention relates to a method and a system for preventing an exhaust inflow of a vehicle which lowers interior pressure during a travel of the vehicle, thereby preventing exhaust from being reintroduced into an interior of the vehicle and making the interior of the vehicle comfortable at the same time.

2. Description of Related Art

In general, an interior of a vehicle is manufactured to shield exterior air but some air is communicated between the interior and exterior of the vehicle due to a manufacturing error or a limit in assembling the vehicle, in which case if the vehicle travels, an interior pressure of the vehicle lowers, causing exhaust to be reintroduced into the interior of the vehicle due to a pressure difference between the interior and the exterior of the vehicle.

In detail, this phenomenon is not problematic as an interior pressure drop is damped by exterior air introduced into the interior by an air conditioner, but when the air conditioner circulates interior air again, an interior pressure of the vehicle lowers and thus there is a strong tendency for contaminated exterior air to be introduced.

In particular, when the vehicle travels while the interior pressure is low, the exhaust of the vehicle discharged to a rear side of the vehicle is reintroduced into the interior of the vehicle through a gap of a rear portion of the body, contaminating interior air.

Meanwhile, if exterior air is introduced during a freeze-up or an intense heat season period, an interior temperature is changed by exterior cold or hot air, causing an interior environment to be changed.

Thus, a technology for introducing exterior air into an interior of a vehicle through an operation of an air conditioning system to settle a pressure difference between the interior and exterior of the vehicle, and regulating a temperature of introduced exterior air to settle a pressure difference between the interior and exterior of the vehicle generated during a travel of the vehicle while an interior environment of the vehicle is maintained at the same, thereby preventing reintroduction of exhaust gas is required.

A technology for interrupting the introduction of exterior air has been proposed to prevent exhaust of a preceding vehicle from being introduced into an interior of the vehicle, but a technology for detecting reintroduction of exhaust of a vehicle into an interior of the vehicle due to a pressure difference between the interior and the exterior of the vehicle to settle a pressure difference between the interior and the exterior of the vehicle and interrupting reintroduction of exhaust in advance has not be proposed yet.

The items described as the related art are just to help understanding of the background of the present invention, and shall not be construed to admit that they belong to the related art well known to those skilled in the art to which the present invention pertains.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method and a system for preventing an exhaust inflow of a vehicle which introduces exterior air through an air conditioning apparatus according to an exhaust concentration of the vehicle reintroduced into the interior of the vehicle due to a pressure difference between the interior and exterior of the vehicle during a travel of the vehicle to discharge and interrupt the introduced exhaust and regulates a temperature, an amount and a speed of the introduced exterior air to provide a driver with a comfortable interior environment.

In an aspect of the present invention, a method of preventing an exhaust inflow, may include a measurement step of measuring a concentration of exhaust introduced into an interior of a vehicle through an exhaust detecting sensor installed in the interior of the vehicle, and comparing the concentration of the exhaust with a reference concentration, an introduction step of controlling an air door of an air conditioning apparatus to introduce more exterior air into the interior of the vehicle so as to increase an interior pressure when the concentration of the introduced exhaust is thicker than the reference concentration, and a blowing step of controlling a blower of the air conditioning apparatus to increase an amount of air discharged into the interior of the vehicle to increase the interior pressure when the thick concentration of the exhaust is maintained in the vehicle.

The measurement step is performed after it is determined that a travel speed of the vehicle is higher than a reference speed and a distance between the vehicle and a preceding vehicle is larger than a reference distance.

The introduction step may further include a temperature regulating step of controlling a temp door of the air conditioning apparatus and regulating a temperature of air discharged into the interior of the vehicle when a temperature of exterior air introduced through the air door deviates from a predetermined temperature section.

The blowing step may further include a wind direction regulating step of, when a thick concentration of the exhaust is maintained in the vehicle, controlling a wind direction regulating door of the air conditioning apparatus such that a discharge direction of the air introduced into the interior of the vehicle directs the breast of the driver.

In the wind direction regulating step, the introduced exhaust is pushed out to a rear side of the vehicle by allowing the wind direction regulating door to discharge the air introduced into the interior of the vehicle through a discharge opening provided on a front surface of a driver's seat and a passenger seat.

In another aspect of the present invention, a system for preventing an exhaust inflow, may include an air door of an air conditioning apparatus for regulating an amount of introduced interior and exterior air, a blower of the air conditioning apparatus for regulating an discharge amount of air having passed through the air door, an exhaust detecting sensor for measuring a concentration of exhaust in an interior of a vehicle, and a controller storing a reference concentration for the exhaust to, when the concentration of the exhaust is thicker than the reference concentration, control the air door to further introduce an exterior air into the interior of the vehicle, and when a thick concentration of the exhaust is maintained, control the blower of the air conditioning apparatus to increase an amount of air introduced into the interior of the vehicle.

The apparatus may further include a wind direction regulating door for regulating a discharge direction of air introduced into the interior of the vehicle, wherein when the thick concentration of the exhaust is maintained, the controller controls a discharge direction of the air discharged through the wind direction regulating door to direct the breast of the driver.

The apparatus may further include a vehicle speed sensor for detecting a travel speed of the vehicle, wherein the controller stores a reference speed, and measures the concentration of exhaust and controls the air door and the blower when the travel speed of the vehicle is equal to or higher than the reference speed.

The apparatus may further include a vehicle distance sensor for detecting a distance between the vehicle and a preceding vehicle, wherein the controller stores a reference distance, and measures the concentration of the exhaust and controls the air door and the blower when the distance of the vehicle is equal to or higher than the reference distance.

The apparatus may further include a temp door of the air conditioning apparatus for regulating a temperature of exterior air introduced into the interior of the vehicle, wherein when the temperature of the exterior air introduced through the air door deviates from a predetermined temperature section, the controller controls the temp door to regulate the temperature of an introduced exterior air.

The exhaust detecting sensor is provided in a trunk room or a rear side interior space of the vehicle.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart of a method of preventing an exhaust inflow according to an exemplary embodiment of the present invention.

FIG. 2 is a block diagram of a system for preventing an exhaust inflow according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a method and a system for preventing an exhaust inflow according to exemplary embodiments of the present invention will be described with reference to the accompanying drawings.

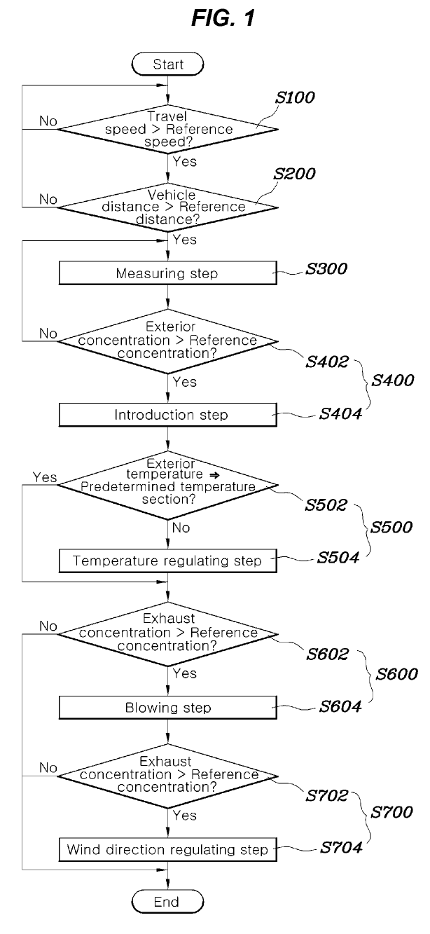

FIG. 1 is a flowchart of a method of preventing an exhaust inflow according to an exemplary embodiment of the present invention. The method of preventing an exhaust inflow of the present invention includes: a measurement step S300 of measuring a concentration of exhaust introduced into an interior of a vehicle through an exhaust detecting sensor installed in the interior of the vehicle, and comparing the concentration of the exhaust with a reference concentration, an introduction step S400 of controlling an interior/exterior air door of an air conditioning apparatus to introduce more exterior air into the interior of the vehicle in S404 so as to increase an interior pressure when the concentration of the introduced exhaust is thicker than the reference concentration in S402, and a blowing step S600 of controlling a blower of the air conditioning apparatus in S604 to increase an amount of air discharged into the interior of the vehicle to increase the interior pressure when the thick concentration of the exhaust is maintained in S602.

In detail, in the method of preventing an exhaust inflow, if exhaust of the vehicle is reintroduced into the interior of the vehicle due to a pressure difference between the interior and the exterior of the vehicle while the vehicle travels at a high speed, the exhaust sensor detects the introduced exhaust and measures a concentration of the exhaust.

In this case, when the measured concentration of the exhaust is thicker than the reference concentration, exterior air is introduced through the interior/exterior air door of the air conditioning apparatus, in which case an opening state of the interior/exterior air door is controlled according to the measured concentration of the exhaust gas, and when an opening degree of an exterior air introducing part of the interior/exterior air door increases so that an amount of introduced exterior air is increased when the concentration of the exhaust gas is thick.

However, in a state where exterior air is introduced according to the setting of a driver, the set state is maintained, reflecting an intention of the driver, and when the concentration of the exhaust is thick, an opening degree of the interior/exterior air door increases to increase an interior pressure.

Meanwhile, if the concentration of the exhaust is maintained in thick state or becomes thicker, a blower of the air conditioning apparatus is controlled, and reintroduction of the exhaust gas can be prevented in advance and the driver can be provided with a comfortable environment by increasing an amount of air discharged into the interior of the vehicle and a discharge speed of air and, accordingly, promptly settling a pressure difference between the interior and exterior of the vehicle.

To this end, first, the method according to the exemplary embodiment of the present invention further includes: a speed detecting step S100 of detecting a travel speed of the vehicle through a vehicle speed sensor, and a distance detecting step S200 of detecting a distance from a preceding vehicle through a vehicle distance sensor.

In detail, when a general vehicle travels at a high speed, a pressure of an interior of the vehicle becomes lower than an exterior pressure, and thus exhaust gas discharged from the vehicle is reintroduced into the interior of the vehicle. Thus, when a travel speed detected through the vehicle speed sensor is a speed by which an interior and exterior pressure difference of the vehicle is generated, exterior air is introduced through control of the air conditioning apparatus, increasing an interior pressure.

It is because that exhaust of a vehicle is generally not reintroduced as a pressure difference between an interior and an exterior of the vehicle is not generated while the vehicle travels at a low speed, whereas when the vehicle travels at a high speed, as a speed of the exterior air of the vehicle increases and a pressure of the exterior air is lowered, exhaust of the vehicle is reintroduced into the interior of the vehicle due to a vortex phenomenon.

Meanwhile, when exterior air is introduced while the vehicle is close to a preceding vehicle, exhaust of the preceding vehicle is introduced into the interior of the vehicle. Thus, after a distance from a preceding vehicle is detected through the vehicle distance sensor and a distance from which exhaust of the preceding vehicle is not introduced is determined, exterior air needs to be introduced.

That is, when exterior air is introduced to interrupt reintroduction of exhaust gas as a travel speed of the vehicle is a predetermined speed or higher and thus an interior pressure is lowered, if the vehicle travels close to the preceding vehicle, the exhaust of the preceding vehicle is introduced into the interior of the vehicle consequently. Thus, it is preferable that after both the travel speed and the vehicle distance from the preceding vehicle are determined, exterior air is introduced according to the exhaust concentration.

The introduction step S400 further includes a temperature regulating step S500 of controlling a temp door of the air conditioning apparatus and regulating a temperature of air discharged into the interior of the vehicle in S504 when a temperature of exterior air introduced through the interior/exterior air door deviates from a predetermined temperature section in S502.

Here, the predetermined temperature section may be a temperature section containing a set temperature set by the driver, or may be a temperature section within a range where an interior temperature is not changed with reference to the temperature.

The temp door is controlled because when exterior air is introduced in a freeze-up or an intense heat season period, cold exterior air in the freeze-up or hot air in the intense heat season period is introduced into the interior of the vehicle, generating a problem of changing the interior temperature.

Meanwhile, if a pressure difference between the interior and the exterior of the vehicle is settled while the interior temperature is maintained in a predetermined temperature section by regulating a temperature of exterior air introduced through the temp door, control of the air conditioning apparatus including the temp door is stopped while minimizing air conditioning load.

Thus, when exterior air is introduced to settle a pressure difference between the interior and exterior of the vehicle generated during a high-speed travel, as the temp door of the air conditioning apparatus is controlled to regulate a temperature of the air discharged into the interior of the vehicle, introduction of the exhaust is interrupted and the introduced exhaust is discharged while a change of the interior temperature is minimized, thereby making it possible to maintain an interior environment and provide comfortable air.

Meanwhile, the blowing step S600 further includes a wind direction regulating step S700 of, when a thick concentration of the exhaust is maintained in S702, controlling a wind direction regulating door of the air conditioning apparatus in S704 such that a discharge direction of the air discharged into the interior of the vehicle directs the breast of the driver.

In the wind direction regulating step S700, the wind direction regulating door allows the air discharged into the interior of the vehicle to be discharged through discharge openings formed in front surfaces of the driver's seat and a passenger seat.

In general, air discharge openings provided in the interior of the vehicle include a defrost through which air is charged toward a windshield glass at upper end of the driver's seat and the passenger seat, a bent provided on a front surface of the driver such that air is discharged toward the breast of the driver, and a floor through which air is discharged from a lower end below a foot of the driver, and in the present technology, the wind direction regulating door is controlled such that air is discharged through a vent provided on a front surface of the driver when the air is discharged into the interior of the vehicle.

Accordingly, as the wind direction regulating door is controlled such that the air is discharged through the vent provided on a front surface of the driver, an interior pressure increases promptly and the introduced exhaust is discharged by pushing out it to a rear side of the vehicle.

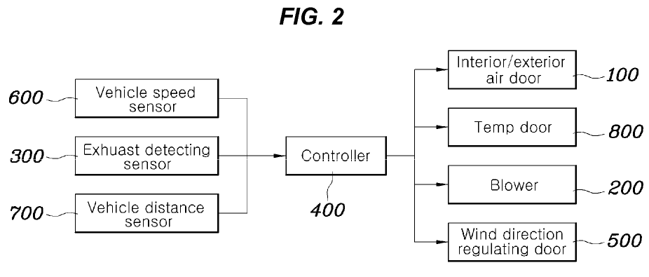

FIG. 2 is a block diagram of a system for preventing an exhaust inflow according to an exemplary embodiment of the present invention. The system for preventing an exhaust inflow according to the exemplary embodiment of the present invention includes an interior/exterior air door 100 of an air conditioning apparatus for regulating an amount of introduced interior and exterior air, a blower of the air conditioning apparatus 200 for regulating an discharge amount of air having passed through the interior/exterior door 100, an exhaust detecting sensor 300 for measuring a concentration of exhaust in the interior of the vehicle, and a controller 400 storing a reference concentration for exhaust to, when a concentration of exhaust is thicker than the reference concentration, controlling the interior/exterior air door 100 to further introduce exterior air into the interior of the vehicle, and when the thick concentration of the exhaust is maintained, controlling a blower 200 of the air conditioning apparatus to increase an amount of air discharged into the interior of the vehicle.

The apparatus according to the exemplary embodiment of the present invention further includes a wind direction regulating door 500 for regulating a discharge direction of air discharged into the interior of the vehicle, and when the thick concentration of the exhaust is maintained, the controller 400 controls a discharge direction of the air discharged through the wind direction regulating door 500 to direct the breast of the driver.

Further, as the wind direction regulating door 500 allows the air discharged into the interior of the vehicle through the discharge openings provided on a front surface of the driver's seat and the passenger seat, the discharged air promptly increases an interior pressure and pushes out the introduced exhaust to a rear side of the vehicle to discharge the exhaust.

Meanwhile, the apparatus according to the exemplary embodiment of the present invention further includes a vehicle speed sensor 600 for detecting a travel speed of the vehicle, and the controller 400 stores a reference speed for a travel speed, and measures a concentration of exhaust and controls the interior/exterior air door 100 and the blower 200 when a travel speed of the vehicle is the reference speed or higher.

It is because when the vehicle travels at a high speed, an interior pressure becomes lower than an exterior pressure and thus discharged exhaust of the vehicle is reintroduced into the interior of the vehicle.

Further, the apparatus according to the exemplary embodiment of the present invention further includes a vehicle distance sensor 700 for detecting a distance from the preceding vehicle, and the controller 400 stores a reference distance for a vehicle distance, and measures a concentration of exhaust and controls the interior/exterior air door 100 and the blower 200 when the distance of the vehicle is the reference distance or longer.

It is because if exterior air is introduced into the interior of the vehicle while the vehicle is close to the preceding vehicle, exhaust of the preceding vehicle is introduced, contaminating interior air.

That is, the controller 400 determines a travel speed and a vehicle distance through the vehicle speed sensor 600 and the vehicle distance sensor 700 to originally interrupt introduction of exhaust, and controls the interior/exterior air door 100 and the blower 200 according to a concentration of the exhaust to promptly discharge interior air contaminated by exhaust when the exhaust is detected, thereby making it possible to promptly discharge the interior air contaminated by the exhaust and provide a more comfortable environment to the driver.

Meanwhile, the apparatus according to the exemplary embodiment of the present invention further includes a temp door 800 of the air conditioning apparatus for regulating a temperature of air discharged into the interior of the vehicle, and when a temperature of exterior air introduced through the interior/exterior air door 100 deviates from a predetermined temperature section, the controller 400 controls the temp door 800 to regulate a temperature of introduced air.

Here, the predetermined temperature section may be a temperature section containing a set temperature set by the driver, or may be a temperature section within a range where an interior temperature is not changed with reference to the temperature.

The temp door 800 is controlled because when exterior door is introduced in a freeze-up or an intense heat season period, cold exterior air in the freeze-up or hot air in the intense heat season period is introduced into the interior of the vehicle, generating a problem of changing the interior temperature.

Thus, the temp door 800 is controlled such that a temperature of exterior introduced air reaches a predetermined temperature section, and if a pressure difference between the interior and exterior of the vehicle is settled while an interior temperature is maintained in the predetermined temperature section, the temp door 800 is controlled to be stopped to minimize an air conditioning load.

Thus, when exterior air is introduced to settle a pressure difference between the interior and exterior of the vehicle generated during a high-speed travel, as the temp door 800 of the air conditioning apparatus is controlled to regulate a temperature of the air discharged into the interior of the vehicle, introduction of the exhaust is interrupted and the introduced exhaust is discharged while a change of the interior temperature is minimized, thereby making it possible to maintain an interior environment and provide comfortable air.

Meanwhile, the exhaust detecting sensor 300 is provided in a trunk room or a rear seat interior space of the vehicle. Of course, the exhaust detecting sensor 300 may be provided at any place of the interior of the vehicle, but it is preferable that the exhaust detecting sensor 300 is installed in a trunk room, a rear side peripheral portion, or a glass peripheral portion of a side surface of the interior of the vehicle.

It is because as an interior pressure decreases during a high-speed travel of the vehicle, exhaust tends to be introduced into a space of the bottom of a rear side of the vehicle or the trunk where air can be introduced when the exhaust discharged due to a difference from the exterior pressure is reintroduced.

That is, the exhaust sensor is provided at a rear side of the vehicle to detect reintroduced exhaust of the vehicle, and exterior air is promptly introduced through the air conditioning apparatus according to the detected concentration of exhaust gas to increase an interior pressure, thereby making it possible to originally prevent the driver from being exposed to exhaust.

According to the above-described method and apparatus for preventing an exhaust inflow of a vehicle, exhaust of a vehicle can be originally prevented from being reintroduced into an interior of the vehicle and an interior environment of the vehicle can be maintained comfortably, by settling a pressure difference of the interior and exterior of the vehicle generated during a travel of the vehicle.

In detail, a pressure difference between the interior and exterior of the vehicle can be settled by detecting a travel speed of the vehicle and introducing exterior air when the vehicle travels at a speed by which a pressure between the interior and exterior of the vehicle is generated.

Meanwhile, an exhaust inflow of a preceding vehicle can be prevented by detecting a distance from a preceding vehicle and introducing exterior air when the distance from the preceding vehicle is a reference distance or more.

That is, a pressure difference between the interior and exterior of the vehicle can be settled to prevent exhaust from being introduced into the interior of the vehicle by determining a travel speed and a distance from a preceding vehicle, measuring a concentration of the exhaust gas reintroduced due to the pressure difference between the interior and exterior of the vehicle, and controlling the air conditioning apparatus according to the measured concentration to introduce exterior air.

In describing the effects due to the control of the air conditioning apparatus in detail, an interior pressure can be increased more promptly to provide comfortable interior air by controlling a blower 200 of the air conditioning apparatus according to a concentration of exhaust to increase an amount and a speed of introduced air and controlling a wind direction regulating door 500 such that a discharge direction is a predetermined direction.

Furthermore, in the case of a freeze-up or an intense heat season period, a driver can be provided with a more comfortable environment by regulating a temperature of air discharged into the interior of the vehicle through a temp door 800 and minimizing a change in an interior temperature due to introduction of exterior air.

According to the above-described method and apparatus for preventing an exhaust inflow of a vehicle, exhaust of a vehicle can be originally prevented from being reintroduced into an interior of the vehicle and an interior environment of the vehicle can be maintained comfortably, by settling a pressure difference of the interior and exterior of the vehicle generated during a travel of the vehicle.

In detail, a pressure difference between the interior and exterior of the vehicle can be settled by detecting a travel speed of the vehicle and introducing exterior air when the vehicle travels at a speed by which a pressure between the interior and exterior of the vehicle is generated.

Meanwhile, an exhaust inflow of a preceding vehicle can be prevented by detecting a distance from a preceding vehicle and introducing exterior air when the distance from the preceding vehicle is a reference distance or more.

That is, a pressure difference between the interior and exterior of the vehicle can be settled to prevent exhaust from being introduced into the interior of the vehicle by determining a travel speed and a distance from a preceding vehicle, measuring a concentration of the exhaust gas reintroduced due to the pressure difference between the interior and exterior of the vehicle, and controlling the air conditioning apparatus according to the measured concentration to introduce exterior air.

In describing the effects due to control of the air conditioning apparatus in detail, an interior pressure can be increased more promptly to provide comfortable interior air by controlling a blower of the air conditioning apparatus according to a concentration of exhaust to increase an amount and a speed of introduced air and controlling a wind direction regulating door such that a discharge direction is a predetermined direction.

Furthermore, in the case of a freeze-up or an intense heat period, a driver can be provided with a more comfortable environment by regulating a temperature of air discharged into the interior of the vehicle through a temp door 800 and minimizing a change in an interior temperature due to introduction of exterior air.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of preventing an exhaust inflow, comprising:
a measurement step of measuring a concentration of exhaust introduced into an interior of a vehicle through an exhaust detecting sensor installed in the interior of the vehicle, and comparing the concentration of the exhaust with a reference concentration;
an introduction step of controlling an air door of an air conditioning apparatus to introduce more exterior air into the interior of the vehicle so as to increase an interior pressure when the concentration of the introduced exhaust is thicker than the reference concentration; and
a blowing step of controlling a blower of the air conditioning apparatus to increase an amount of air discharged into the interior of the vehicle to increase the interior pressure when the thick concentration of the exhaust is maintained in the vehicle.

2. The method of claim 1, wherein the measurement step is performed after it is determined that a travel speed of the vehicle is higher than a reference speed and a distance between the vehicle and a preceding vehicle is larger than a reference distance.

3. The method of claim 1, wherein the introduction step further includes: a temperature regulating step of controlling a temp door of the air conditioning apparatus and regulating a temperature of air discharged into the interior of the vehicle when a temperature of exterior air introduced through the air door deviates from a predetermined temperature section.

4. The method of claim 1, wherein the blowing step further includes: a wind direction regulating step of, when a thick concentration of the exhaust is maintained in the vehicle, controlling a wind direction regulating door of the air conditioning apparatus such that a discharge direction of the air introduced into the interior of the vehicle directs the breast of the driver.

5. The method of claim 4, wherein in the wind direction regulating step, the introduced exhaust is pushed out to a rear side of the vehicle by allowing the wind direction regulating door to discharge the air introduced into the interior of the vehicle through a discharge opening provided on a front surface of a driver's seat and a passenger seat.

6. A system for preventing an exhaust inflow, comprising:
an air door of an air conditioning apparatus for regulating an amount of introduced interior and exterior air;
a blower of the air conditioning apparatus for regulating a discharge amount of air having passed through the air door;
an exhaust detecting sensor for measuring a concentration of exhaust in an interior of a vehicle; and
a controller storing a reference concentration for the exhaust to, when the concentration of the exhaust is thicker than the reference concentration, control the air door to further introduce an exterior air into the interior of the vehicle, and when a thick concentration of the exhaust is maintained, control the blower of the air conditioning apparatus to increase an amount of air introduced into the interior of the vehicle.

7. The apparatus of claim 6, further including a wind direction regulating door for regulating a discharge direction of air introduced into the interior of the vehicle, wherein when the thick concentration of the exhaust is maintained, the controller controls a discharge direction of the air discharged through the wind direction regulating door to direct the breast of the driver.

8. The apparatus of claim 6, further including a vehicle speed sensor for detecting a travel speed of the vehicle, wherein the controller stores a reference speed, and measures the concentration of exhaust and controls the air door and the blower when the travel speed of the vehicle is equal to or higher than the reference speed.

9. The apparatus of claim 6, further including a vehicle distance sensor for detecting a distance between the vehicle and a preceding vehicle, wherein the controller stores a reference distance, and measures the concentration of the exhaust and controls the air door and the blower when the distance of the vehicle is equal to or higher than the reference distance.

10. The apparatus of claim 6, further including a temp door of the air conditioning apparatus for regulating a temperature of exterior air introduced into the interior of the vehicle, wherein when the temperature of the exterior air introduced through the air door deviates from a predetermined temperature section, the controller controls the temp door to regulate the temperature of an introduced exterior air.

11. The apparatus of claim 6, wherein the exhaust detecting sensor is provided in a trunk room or a rear side interior space of the vehicle.
